(19) United States
(12) Patent Application Publication
(10) Pub. No.: US 2023/0286533 A1
(43) Pub. Date: Sep. 14, 2023

(54) METHOD FOR DETECTING OBJECTS IN A VEHICLE DETECTION FIELD COMPRISING AN INTERIOR AND AN OUTER REGION OF A VEHICLE

(71) Applicant: Valeo Schalter und Sensoren GmbH, Bietigheim-Bissingen (DE)

(72) Inventor: Enmanuel Garcia-Rus, Bietigheim-Bissingen (DE)

(73) Assignee: Valeo Schalter und Sensoren GmbH, Bietigheim-Bissingen (DE)

(21) Appl. No.: 17/793,148

(22) PCT Filed: Jan. 12, 2021
(86) PCT No.: PCT/EP2021/050425

§ 371 Date: Jul. 15, 2022

(30) Foreign Application Priority Data
Jan. 17, 2020 (DE) 10 2020 101 048.6

(51) Int. Cl. B60W 60/00

(52) U.S. Cl. CPC B60W 60/001; B60W 2554/80; B60W 2420/42; B60W 2420/62

(57) ABSTRACT

The present invention relates to a method for detecting objects in a first vehicle detection field (10a), which comprises an interior (12) and an outer region (14) of a vehicle (16), by means of a first sensor unit (18a) of the vehicle (16). The method comprises the following steps: Detecting an object in the outer region (14) of the first vehicle detection field (10a) with the first sensor unit (18a) as first detection data; detecting an object in the interior (12) of the first vehicle detection field (10a) with the first sensor unit (18a) as second detection data; and processing the first and second detection data in a computing unit. The invention also relates to a corresponding detection system.

The present invention relates to a method for detecting objects in a vehicle detection field that comprises an interior and an exterior region of a vehicle. The present invention also relates to a detection system for detecting objects in a vehicle detection field. The invention likewise relates to a driving assistance system comprising such a detection system and to a vehicle having such a detection system or driving assistance system. The present invention can furthermore relate to a computer program comprising instructions that, when the computer program is executed by a computer, cause the latter to carry out steps of the method. The present invention can furthermore relate to a data carrier signal that transmits the computer program. The present invention can furthermore comprise a computer-readable medium comprising instructions that, when executed by a computer, cause the latter to carry out steps of the method.

US laid-open publication US 2018/0072156 A1 discloses an A-pillar video monitoring system for a motor vehicle for allowing a driver to see traffic conditions, such as children running or approaching cars, from the sides of the vehicle. For this purpose, left or right video cameras are mounted outside on the left or right side of the motor vehicle. Each camera attachment has a generally laterally oriented miniature video camera viewing angle and a housing or a cover that is arranged in the form of a flow-optimized fairing over the associated camera to protect it and minimize the amount of protrusions laterally from the side of the vehicle. The fairing also avoids unnecessary airflow turbulence, thereby optimizing the vehicle. The images viewed by these camera arrangements are reproduced on a curved screen or monitor that is seamlessly integrated into the A-pillars of the vehicle. The driver can keep a close eye on conditions on all sides without having to take their attention off the road. In the event of an airbag deployment, the curved monitor opens to protect the driver and the airbag deploys.

In a similar field, the laid-open publication EP 1 974 998 A1 discloses a driving assistance method and apparatus for capturing a region masked in the form of a blind spot, which occurs due to the presence of a pillar of a vehicle when looking into the mirror from the driver's position and is created owing to the pillar. The apparatus captures a drivers head position, captures the angle of the rear-view mirror, calculates the region masked in the form of a blind spot on the basis of the captured driver's head position and the captured angle of the rear-view mirror, and projects an image of the region corresponding to the blind spot onto the pillar, wherein the projected image is formed from image data originating from at least one blind-spot camera mounted on the exterior of the vehicle.

With increasing automation of vehicles, the need to capture the vicinity of vehicles by sensors increases in general. The detection of a vehicle detection field in the light of autonomous driving is becoming increasingly important. On the one hand, surroundings information or object detections from the exterior region of a vehicle are required to enable safe interaction of an autonomously driving vehicle with its environment. Vicinity capturing sensor units mounted on the exterior of the vehicle have been used hitherto for this purpose. On the other hand, information or object detections from the interior are also used, however, to enable gesture recognition of the driver or to capture the driver's behavior in general, so that the driver's well-being can be ensured and they also perceive a driving experience that is as intuitive as possible. Interior monitoring sensor units mounted inside the vehicle have hitherto been used for this purpose.

Driving assistance methods and related driving assistance systems according to the prior art are thus systems that require additional sensors or sensor units, computing systems and screen systems in order to implement the aforementioned methods, for example to compensate for the blind spot. This means an increased energy requirement and thus a shorter range of the vehicle. Furthermore, additional components are required, which increases the expense for production and assembly. In addition, additional components increase the overall weight of the vehicle.

Proceeding from the prior art mentioned above, the invention is therefore based on the object of specifying an improved method for detecting objects in a vehicle detection field, and also a corresponding detection system or driving assistance system and vehicle.

The object is achieved according to the invention by the features of the independent claims. Advantageous configurations of the invention are specified in the dependent claims.

According to the invention, a method for detecting objects in a first vehicle detection field is thus specified, which comprises an interior and an exterior region of a vehicle. The method comprises at least the following steps: detecting an object (e.g., a further vehicle or any other object in the vicinity or exterior region of the vehicle) in the exterior region (e.g., in the blind-spot region or in the close range in front of the vehicle) of the first vehicle detection field (or in the exterior region of the vehicle) with the first sensor unit as first detection data, and detecting an object (e.g., person or occupant of the vehicle, such as the driver or user of the vehicle) in the interior of the first vehicle detection field (or in the interior of the vehicle) with the first sensor unit as second detection data. It is therefore possible to use exactly one sensor unit to detect an object in the exterior region of the first vehicle detection field (e.g., in the blind-spot region or close range) and an object in the interior (e.g., person or occupant) of the first vehicle detection field. The first and second detection data are then processed in or using a computing unit.

According to the invention, a detection system for detecting objects in a first vehicle detection field, which comprises an interior and an exterior region of a vehicle, is furthermore specified. The detection system comprises: a first sensor unit, designed to detect an object (e.g., a further vehicle or any other object in the vicinity or exterior region of the vehicle) in the exterior region (e.g., in the blind-spot region or in the close range in front of the vehicle) of the first vehicle detection field (or in the exterior region of the vehicle) as first detection data, and for detecting an object (e.g., person or occupant of the vehicle, such as the driver or user of the vehicle) in the interior of the first vehicle detection field (or in the interior of the vehicle) as second detection data. The detection system or the sensor unit additionally comprises a computing unit for processing the first and second detection data. Features or configurations of the method are likewise preferred for the detection system.

A driving assistance system for providing a driving assistance function comprising a previously described detection system is also in accordance with the invention. The driving assistance system can furthermore have a control unit, which is designed to provide the driving assistance function based on the (first and second) detection data. The driving assistance system can also generally comprise means for carrying out the steps of the method described above. The driving assistance function can, for example, provide assistance with autonomous or semi-autonomous driving, in particular of corresponding autonomous or semi-autonomous vehicles. The driving assistance function can, for example, provide assistance to a driver of the vehicle in different driving situations. The driving assistance function can in particular be automatic emergency braking, automatic lane keeping (lane keep assist) or the like.

The invention furthermore specifies a vehicle having the detection system mentioned above. The invention also specifies a vehicle having the aforementioned driving assistance system. For example, the vehicle may be a motor vehicle or truck.

Furthermore, the invention can specify a computer program comprising instructions that, when the computer program is executed by a computer, cause the latter to carry out steps of the method. A computer program is a collection of instructions for carrying out a specific task that is designed to solve a specific class of problems. The instructions of a program are designed to be executed by a computer, wherein it is necessary for a computer to be capable of executing programs in order for it to function.

The invention can further specify a data carrier signal that transmits the computer program. The invention can further specify a computer-readable medium comprising instructions that, when executed by a computer, cause the latter to carry out steps of the method.

The basic concept of the present invention is to expand the function of sensor units, so that the function of a plurality of sensor units are combined into fewer sensor units. In a specific example, this means that, for example, a previously separate vicinity capturing sensor unit (e.g., sensor unit for blind-spot detection) can be combined with a previously separate interior monitoring sensor unit (e.g., sensor unit for occupant detection) to form one correspondingly positioned sensor unit. Accordingly, the need for sensor units is halved. The function of occupant recognition is thus combined with road detection. It is furthermore a basic concept of the present invention to define the corresponding position or positioning of the sensor unit, in particular on the A-pillar of the vehicle in the interior of the vehicle.

Furthermore, improved detection of the eye position of the occupants is possible when the respective occupant turns their face. The functionality of the (autonomous or semi-autonomous) driving assistance system (e.g., emergency braking system) is also improved due to an optimally settable angle to the detection target. A position of the sensor unit closer to the front or the hood front of the vehicle has a better detection angle, for example when a pedestrian is crossing a road with obstacles. Such an obstacle can be a parked car, for example. An (autonomous or semi-autonomous) emergency braking system is a predictive driving assistance system for motor vehicles that warns the driver in the event of danger, provides assistance with emergency braking, acts as a brake assistant, and/or brakes automatically. This is intended to avoid colliding with the obstacle and/or reduce the collision speed. For this purpose, previously known vehicles having emergency brake assistants usually have separate sensors for ascertaining distances, acceleration, steering angle, steering wheel angle and pedal positions.

A further advantage in the case of an internally installed sensor unit is the multifunctional use of a windscreen cleaning system of the vehicle. As a result, no additional cleaning system for the sensor unit is required.

Furthermore, a sensor unit (e.g., camera) of the driving assistance system can provide a drive system of the vehicle with enough information to reach its destination and drive the vehicle in a mode other than the normal mode, for example in the emergency mode. In the normal mode, all sensors work correctly. In contrast, the emergency mode is suitable only for driving the vehicle to a workshop or to another parking space. The sensor unit(s) can here serve as (a) redundant sensor unit(s) or as backup for a main front camera. In other words, the sensor unit(s) can also be used in addition to a conventional front camera. This means that the sensor unit(s) supports the redundancy or can be used in the emergency mode.

Since the vehicle usually has transparent windows or, in the case of a convertible, is open, the at least one sensor unit can detect through the interior and the exterior region. This consequently obviates the need for further sensor units. This results in lower weight and lower costs due to fewer detection system components and less energy consumption due to less computing capacity being required.

The interior can also be referred to as the interior region of the vehicle. In particular, the interior can be the space of the vehicle in which a person or occupant of the vehicle (e.g., driver or user) is located (e.g., passenger compartment).

The exterior region can be limited to at least a region outside the vehicle, adjacent to the vehicle sides, i.e., on the driver's side and the passenger's side. However, the exterior region can additionally also refer to at least a region outside of the vehicle that is next to the front and/or rear of the vehicle.

Where the teaching of the invention discloses at least one sensor unit, this means that it can apply to any sensor unit. Consequently, if the vehicle has two or more sensor units, each of these sensor units can, but does not need to, have the respective features of the claim.

According to an advantageous embodiment of the invention, the method is furthermore suitable for detecting objects in a second vehicle detection field, which comprises an interior and an exterior region of the vehicle, by means of at least one second sensor unit of the vehicle. The method can here furthermore comprise the following steps: detecting an object in the exterior region of the second vehicle detection field with the second sensor unit as first detection data; and detecting an object in the interior of the second vehicle detection field with the second sensor unit as second detection data. The system can therefore comprise a second sensor unit, which, in particular, can be structurally identical to the first sensor unit. This second sensor unit is also designed both for detecting an object in the exterior region and detecting an object in the interior. In this way, optimum coverage of the region to be detected can be achieved.

The detection system (or the corresponding driving assistance system or vehicle) can have at least a first sensor unit with a first vehicle detection field having the features of the sensor unit and a second sensor unit with a second vehicle detection field having the features of the sensor unit. The two vehicle detection fields allow detection of as much of the interior and of the exterior region as possible. In regions where the vehicle detection fields intersect, a congruence check can optionally be carried out. This reduces possible false detections. If, for example, a driver has, for reasons of anatomy, a partially drooping eyelid on only one side, a false alarm can be avoided due to detection of the other half of the face with the wide-open eyelid. This is also called a congruence check.

In an advantageous embodiment, the first sensor unit and the second sensor unit are arranged opposite one another on two vehicle columns of the same type. Columns of the same type are, for example, two A-pillars, two B-pillars or two C-pillars. With this arrangement, the aforementioned advantages of the congruence check lead to particularly reliable detection results. In this way, the respective exterior region of the vehicle opposite a pillar can also be detected symmetrically to the opposite exterior region, so that uniformly reliable detection results of the lateral vehicle side region are available.

According to an advantageous embodiment, the object in the exterior region is in a blind-spot region of the vehicle. The object can be, for example, another vehicle that is located in the blind-spot region of the ego vehicle.

According to an advantageous embodiment, the object in the interior is an occupant (e.g., driver) of the vehicle. In particular, a gesture, line of sight and/or an eye status (e.g. closing eye) of the occupant can be detected. In particular, a position of the occupant's head, in particular a position of the occupant's eyes (eye position), can be detected.

The sensor unit may be arranged in the interior of the vehicle in a manner such that detection of the interior and detection of the exterior region is carried out using the respective sensor unit. The detection of the interior can comprise occupant detection. The detection of the exterior region can comprise blind-spot detection. The occupant detection and the blind-spot detection can be carried out together. However, it is also possible that only occupant detection or only blind-spot detection takes place, or that the detection is generally directed toward a different detection in the interior or exterior region. The corresponding arrangement of the at least one sensor unit in the interior can therefore be sufficient to detect the inside and outside of the vehicle. Since the vehicle usually has transparent windows or, in the case of a convertible, is open, the at least one sensor unit can detect through the interior region, or the interior, into the exterior region. Thus, at least one sensor unit is sufficient, for example, to detect at least one occupant and a significant exterior region, in particular a blind spot.

At least the driver, but preferably also the front passenger and/or persons in the rear seats, can be regarded as occupants.

In road traffic, the blind spot or blind-spot region is the lateral region of the vehicle, or the region in front of and behind the vehicle, that cannot be seen by drivers located inside closed vehicles despite rear-view mirrors. The size of this region varies depending on the number of windows and rear-view mirrors.

Such an arrangement saves costs, weight and computing capacity. In addition, the at least one sensor unit does not need to be protected as carefully from external influences, like moisture, dust, dirt, stone chips or the like, as is the case with exterior installation. The at least one sensor unit is thus exposed to fewer disruptive influences and requires less construction outlay.

According to a particularly advantageous embodiment of the invention, the sensor unit is arranged on an A-pillar of the vehicle in the interior of the vehicle, in particular in a manner such that the sensor unit is directed into the interior of the vehicle but can also capture the exterior region of the vehicle or in a manner such that both the interior and the exterior region are captured.

A particular advantage of the arrangement on an A-pillar is that mounting to the A-pillar allows a particularly reliable driver or occupant detection. For example, gestures, line of sight or eye status (e.g., closing eyes) of the occupant/driver can be detected particularly well. An advantage of the arrangement on the A-pillar is in particular the possibility of detecting the exterior region of the vehicle opposite the A-pillar, in particular with regard to a blind spot. The arrangement on an A-pillar is therefore particularly advantageous since it enables particularly reliable driver or front passenger detection and good detection of the exterior region.

In an alternative embodiment, however, the sensor unit can theoretically also be arranged on a B-pillar or C-pillar in the interior of the vehicle. Even in the event of an arrangement on the B- or C-pillars, the exterior region of the vehicle opposite the corresponding pillar can be reliably detected, in particular with regard to a blind spot.

The arrangement on a pillar in particular enables reliable detection of the exterior region on a vehicle side that lies opposite the respective pillar. Using a specific example, this means that a sensor unit disposed on a pillar on the drivers side can readily detect the exterior region on the front passenger side, and vice versa.

According to an advantageous embodiment of the invention,

the sensor unit is arranged in a manner such that its vehicle detection field extends from a first vehicle side (e.g., from a respective A-pillar of the vehicle) at least across the interior, transversely to a longitudinal axis of the vehicle, to the opposite, second vehicle side (e.g., to the second A-pillar of the vehicle) into the exterior region. Thus, the widest possible region of the interior for detection is covered, with the result that as much information as possible can be detected in order to reduce the number of further sensor units as much as possible.

According to an advantageous embodiment of the invention,

the sensor unit has a vehicle detection field which, starting from the respective sensor unit, forms a horizontal detection cone of at least 110 degrees, in particular at least or approximately 120 degrees. In particular, the horizontal detection cone can be a maximum of 190 degrees. This is possible with current systems. It has been found that it is possible in this way to acquire sufficient detection data covering both the interior region and the exterior region in accordance with the desired requirements. A smaller horizontal detection cone results in too little data. A larger horizontal detection cone leads to an unnecessarily high computational load on the computing system. However, a horizontal detection cone of maximally 360 degrees can also be conceivable.

According to an advantageous embodiment of the invention,

the sensor unit is arranged in a manner such that it has a vehicle detection field, whose horizontal detection cone extends at least from a front corner (e.g., front light) of a first vehicle side of the vehicle (on which in particular the sensor unit is also arranged) up to at least one third of the length of the vehicle (e.g., a B-pillar) on an opposite, second vehicle side. This enables good driver detection. In addition, it enables good detection of the exterior region in that the regions in the direction of travel are reliably detected, so that this is advantageous for accident prevention measures.

In particular, the at least two sensor units, which preferably lie opposite one another, can be arranged in a manner such that the detection fields intersect in the interior and the occupant/driver is thus reliably detected. The at least two sensor units, which preferably lie opposite one another, can likewise be arranged in a manner such that the detection fields intersect in the exterior region and an object in the vehicle's vicinity or exterior region is thus reliably detected.

According to an advantageous embodiment of the invention,

the sensor unit is arranged in a manner such that it has a vehicle detection field, whose horizontal detection cone extends at least from a front corner (e.g., front light) on an opposite, second vehicle side of the vehicle (in particular on the side lying opposite the side on which the sensor unit is also arranged) up to at least two thirds of the length of the vehicle (e.g., a C-pillar) on an opposite, second vehicle side. This enables good driver detection. In addition, it enables good detection of the exterior region in that the regions in the dead angle are reliably detected, so that this is advantageous for accident prevention measures. In particular when there are at least two sensor units, which preferably lie opposite one another, the detection fields intersect in the interior in a manner such that the driver is reliably detected.

According to an advantageous embodiment of the invention,

the sensor unit is arranged in a manner such that it has a vehicle detection field, whose horizontal detection cone extends at least from a central region, disposed on a longitudinal axis of the vehicle, of a front side (e.g., hood front) of the vehicle up to at least one half the length of the vehicle (e.g., between a B-pillar and a C-pillar) on an opposite, second vehicle side. This enables good driver detection. In addition, it enables good detection of the exterior region in that the regions in the direction of travel and possibly also in the dead angle are reliably detected, so that this is advantageous for accident prevention measures. In particular when there are at least two sensor units, which preferably lie opposite one another, the detection fields intersect in the interior in a manner such that the driver is reliably detected. The horizontal detection cone thus particularly preferably extends at least so far that a respective blind spot can also be detected.

According to an advantageous embodiment of the invention,

a driving assistance function, in particular a safety-relevant one, based on the (first and second) detection data is provided by a driving assistance system. Up until now, this has been accomplished using detection data from sensor units whose vehicle detection field lies exclusively, at least almost exclusively, in the exterior region of the vehicle. This is a cost-effective and energy-efficient solution for using sensor units more extensively. In particular, it is possible to set a vehicle behavior (e.g. braking and/or steering).

According to an advantageous embodiment of the invention,

the sensor unit is an optical sensor. The sensor unit, or the optical sensor, can in particular be a camera or a laser scanner. A camera is a photo-technological apparatus that can record static or moving images as detection data on a photographic film or electronically on a digital storage medium or transmit them via an interface. A camera is a cost-effective and at the same time reliable detection means. However, the optical sensor can also be a laser scanner.

If necessary, the camera can also be designed as a thermal imaging camera. A thermal imaging camera, also known as a night vision, thermographic, thermal or infrared camera, is, as was mentioned above, an imaging device, but one which receives infrared radiation. Infrared radiation lies in the wavelength range from around 0.7 micrometers to 1000 micrometers. However, due to the typical emission wavelengths close to the ambient temperature, thermal imaging cameras use the spectral range from around 3.5 micrometers to 15 micrometers, i.e., medium and long-wave infrared. This range is also suitable for measuring and depicting temperatures in the ambient temperature range when the emissivity is known. However, depending on the material, this varies greatly between 0.012 and 0.98. The temperature assignment can be correspondingly imprecise, although this is not critical for automotive applications. Since the normal atmosphere in this range is largely transparent, the lateral irradiation from the sun and artificial light sources hardly has a disruptive effect as long as the distance is merely a few meters. At greater distances, the intrinsic radiation of the air can falsify the result.

The invention is explained in more detail below with reference to the attached drawing on the basis of preferred embodiments. The features shown may each represent an aspect of the invention both individually and in combination. Features of different exemplary embodiments may be transferred from one exemplary embodiment to another.

In the figures:

FIG. 1 shows a schematic top view of a vehicle with two sensor units, arranged on a respective A-pillar, with two intersecting vehicle detection fields, according to a first embodiment of the invention;

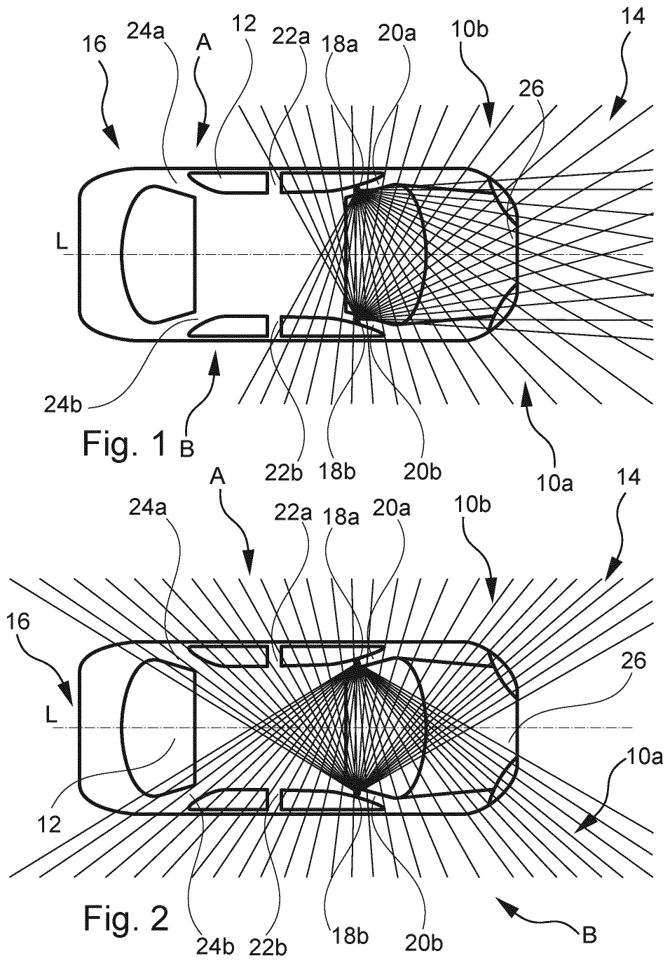

FIG. 2 shows a schematic top view of a vehicle with two sensor units, arranged on a respective A-pillar, with two intersecting vehicle detection fields, according to a second embodiment of the invention;

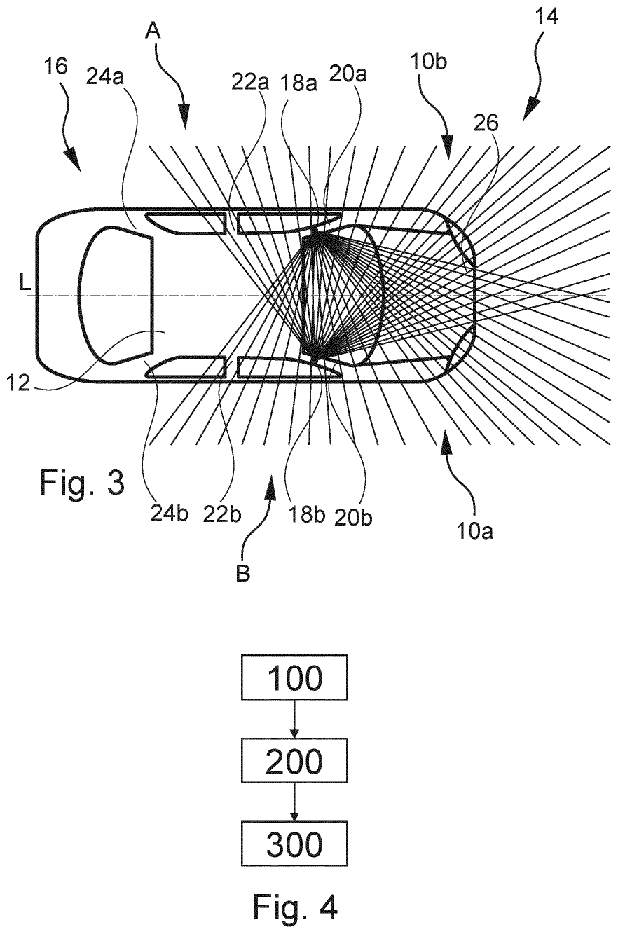

FIG. 3 shows a schematic top view of a vehicle with two sensor units, arranged on a respective A-pillar, with two intersecting vehicle detection fields, according to a third embodiment of the invention; and

FIG. 4 shows a flow chart according to a preferred embodiment of the invention.

FIG. 4 shows a symbolic application of a method for detecting objects in one or more vehicle detection fields 10a, 10b, which comprise an interior 12 and an exterior region 14 of a vehicle 16, with or by means of a first sensor unit 18a. The method has the following steps:
step 100: detecting an object in the exterior region 14 of the first vehicle detection field 10a as first detection data with the first sensor unit 18a, and detecting an object in the interior 12 of the first vehicle detection field 10a with the first sensor unit 18a
step 200: processing the first and second detection data with a computing unit or computing system; and possibly
step 300: providing a (safety-relevant) driving assistance function based on the (processed) first and second detection data by way of a driving assistance system.

It is also possible for two, in particular structurally identical, sensor units to be present, with the result that objects in a second detection field, which comprises a, or the, interior and a, or the, exterior region of the vehicle, are also detected with or by means of a second sensor unit 18b. In this case, step 100 additionally comprises also: detecting an object in the exterior region 14 of the second vehicle detection field 10b as first detection data with the second sensor unit 18b, and detecting an object in the interior 12 of the second vehicle detection field 10b with the second sensor unit 18b.

According to FIGS. 1, 2 and 3, objects in the two vehicle detection fields 10a, 10b are detected as first and second detection data 100 by the first sensor unit 18a with the first vehicle detection field 10a and by the second sensor unit 18b with the second vehicle detection field 10b. The sensor units 18a, 18b are arranged here opposite one another on two pillars of the same type, specifically A-pillars 20a, 20b, of the vehicle 16. The two sensor units 18a, 18b are preferably cameras.

In principle, all the features that apply to one sensor unit 18a, 18b are also applicable to one or more further, preferably all, sensor units.

Both sensor units 18a, 18b are arranged in this case in the interior 12 of the vehicle 16 in a manner such that a detection of the interior 12, in particular an occupant detection, and a detection of the exterior region 14, preferably a blind spot detection, are carried out with the respective sensor unit 18a, 18b. The sensor unit 18b on the front passenger side detects in particular the driver's side and its exterior region as the first vehicle side A. The sensor unit 18a on the driver's side preferably detects the side of the front passenger and its exterior region as the second vehicle side B.

Furthermore, the two sensor units 18a, 18b are arranged on a respective A-pillar 20a, 20b in the interior 12 of the vehicle 16.

At least one sensor unit 18a, 18b is arranged in a manner such that its vehicle detection field 10a, 10b extends from a first vehicle side A, in particular from the respective A-pillar 20a, 20b of the vehicle 16, at least across the interior 12, transversely to a longitudinal axis L of the vehicle 16, to the opposite, second vehicle side B, preferably to the second A-pillar 20a, 20b of the vehicle 16, into the exterior region 14.

As shown symbolically in FIGS. 1, 2 and 3, each sensor unit 18a, 18b preferably has a vehicle detection field 10a, 10b which, starting from the respective sensor unit 18a, 18b, has a horizontal detection cone of at least 110 degrees. In particular, the vehicle detection fields 10a, 10b illustrated in FIGS. 1, 2 and 3 have a horizontal detection cone of (approximately) 120 degrees.

FIGS. 1, 2 and 3 differ in terms of their distribution of the vehicle detection fields 10a, 10b.

According to a first preferred embodiment of the invention according to FIG. 1, both sensor units 18a, 18b are arranged in a manner such that they each have a vehicle detection field 10a, 10b, whose horizontal detection cone extends at least from a front corner (here, e.g., from the front light) of the first vehicle side A (on which the sensor unit 18a, 18b is also arranged) up to at least one third of the length of the vehicle 16 (here, e.g., up to the B-pillar 22a, 22b) on the opposite, second vehicle side B. The length of the vehicle 16 is the length along the longitudinal axis L.

In contrast, according to a second preferred embodiment of the invention according to FIG. 2, both sensor units 18a, 18b are arranged in a manner such that they each have a vehicle detection field 10a, 10b, whose horizontal detection cone extends at least from a front corner (here, e.g., from the front light) on the opposite, second vehicle side B (i.e., e.g., on the side B opposite to the side A, on which the sensor unit 18a is also arranged) up to at least two thirds of the length of the vehicle (here, e.g., up to the C-pillar 24a, 24b) on the opposite, second vehicle side B.

Furthermore, according to a third preferred embodiment of the invention according to FIG. 3, both sensor units 18a, 18b are arranged in a manner such that they each have a vehicle detection field 10a, 10b, whose horizontal detection cone extends at least from a central region, disposed on a longitudinal axis L of the vehicle 16, of a front side, or hood front, 26 of the vehicle 16 up to at least one half the length of the vehicle (here, e.g., to between the B-pillar 22a, 22b and the C-pillar 24a, 24b) on the opposite, second vehicle side. The horizontal detection cone particularly preferably extends so far that a respective blind spot can also be detected.

FIGS. 1, 2 and 3 show an overlap of the vehicle detection fields 10a, 10b. This overlap can be present in the interior 12 or in the exterior region 14 of the vehicle 16. The redundancies of this double detection increase the quality of the detection data and make them more precise and enable more reliable detection, with the result that safety-enhancing measures can follow from this.

### LIST OF REFERENCE SIGNS

10a First vehicle detection field of a first sensor unit
10b Second vehicle detection field of a second sensor unit
12 Interior of a vehicle
14 Exterior region of a vehicle
16 Vehicle
18a First sensor unit
18b Second sensor unit
20a First A-pillar of a vehicle
20b Second A-pillar of a vehicle
22a First B-pillar of a vehicle
22b Second B-pillar of a vehicle
24a First C-pillar of a vehicle
24b Second C-pillar of a vehicle
26 Front or hood front of the vehicle
100 Detecting at least one vehicle detection field, with at least one respective sensor unit, as detection data
200 Processing the detection data with a computing system
300 Setting a safety-relevant vehicle behavior based on the detection data by way of a driving assistance system
L Longitudinal axis of the vehicle
A First side of vehicle
B Second side of vehicle

1. A method for detecting objects in a first vehicle detection field, which comprises an interior and an exterior region of a vehicle, by means of a first sensor unit of the vehicle, the method comprising:
detecting an object in the exterior region of the first vehicle detection field with the first sensor unit as first detection data;
detecting an object in the interior of the first vehicle detection field with the first sensor unit as second detection data;
processing the first and second detection data in a computing unit.

2. The method as claimed in claim 1, the method further comprising
detecting objects in a second vehicle detection field, which comprises an interior and an exterior region of the vehicle, by at least one second sensor unit of the vehicle, wherein detecting objects in the second vehicle detection field comprises:
detecting an object in the exterior region of the second vehicle detection field with the second sensor unit as first detection data;
detecting an object in the interior of the second vehicle detection field with the second sensor unit as second detection data.

3. The method as claimed in claim 2, wherein the first sensor unit and the second sensor unit are arranged opposite one another on two pillars of the same type, of the vehicle.

4. The method as claimed in claim 1, wherein the object in the exterior region is in a blind-spot region of the vehicle.

5. The method as claimed claim 1, wherein the object in the interior is an occupant of the vehicle.

6. The method as claimed in claim 1, wherein the sensor unit is arranged on an A-pillar of the vehicle in the interior of the vehicle.

7. The method as claimed in claim 1, wherein the sensor unit is arranged on a B-pillar or C-pillar of the vehicle in the interior of the vehicle.

8. The method as claimed in claim 1, wherein the sensor unit is arranged in a manner such that its vehicle detection field extends from a first vehicle side, at least across the interior, transversely to a longitudinal axis of the vehicle, to the opposite, second vehicle side into the exterior region.

9. The method as claimed in claim 1, wherein the sensor unit has a vehicle detection field which, starting from the respective sensor unit, forms a horizontal detection cone of at least 110 degrees.

10. The method as claimed in claim 1, wherein further comprising: providing a driving assistance function based on the detection data by way of a driving assistance system.

11. The method as claimed in claim 1, wherein the sensor unit is an optical sensor comprising a camera or a laser scanner.

12. A detection system for detecting objects in a first vehicle detection field, which comprises an interior and an exterior region of a vehicle, comprising:
a first sensor unit for
detecting an object in the exterior region of the first vehicle detection field as first detection data; and
detecting an object in the interior of the first vehicle detection field as second detection data; and
a computing unit for processing the first and second detection data.

13. A driving assistance system for providing a driving assistance function, comprising a detection system as claimed in claim 12; and a control unit to provide the driving assistance function based on the detection data.

14. A vehicle having a detection system as claimed in claim 12.
